(19) United States
(12) Patent Application Publication
(10) Pub. No.: US 2012/0251290 A1
(43) Pub. Date: Oct. 4, 2012

(54) ASPIRATING FACE SEAL, AND A RELATED METHOD THEREOF

(75) Inventors: Norman Arnold Turnquist, Carlisle, NY (US); Rodrigo Rodriguez Erdmenger, Munich (DE); Xiaoqing Zheng, Niskayuna, NY (US); Robbert Christiaan Pannekeet, Munich (DE); Keith Michael Parker, Greer, SC (US)

(73) Assignee: GENERAL ELECTRIC COMPANY, SCHENECTADY, NY (US)

(21) Appl. No.: 13/076,724

(22) Filed: Mar. 31, 2011

(51) Int. Cl. F01D 11/08; F16J 15/44

(52) U.S. Cl. 415/1; 277/355; 277/301; 415/171.1

(57) ABSTRACT

An aspirating face seal includes a primary seal, a secondary seal, and a biasing device. The primary seal includes a first seal component and a second seal component. The first seal component is configured to be coupled to a rotor and rotatable with the rotor. The secondary seal includes a plurality of flexible elements and configured to be disposed between the second seal component and a stator housing. A biasing device is coupled to the second seal component such that the second seal component is biased along an axial direction away from the first seal component during a non-operating condition.

### BACKGROUND

The invention relates generally to aspirating face seals, and more specifically to a secondary seal having a plurality of flexible elements of an aspirating face seal used in machines, for example, a gas turbine engine.

Face seals are used to minimize leakage of a pressurized fluid through a gap between two components from a higher pressure area to a lower pressure area in a machine. Such seals have been used in rotating machines, for example, a steam turbine, a gas turbine, or the like. In applications such as gas turbine engines, aspirating face seals are used to minimize leakage of a fluid such as compressed air or combustion gases between a rotor and a stator. The seals applied to the gaps or leakage paths between the stator and the rotor should be able to compensate for variations in the gaps due to differential thermal and mechanical component expansions during the machine operating cycle.

Conventional aspirating face seals typically have oppositely facing rotatable and non-rotatable seal elements, with the rotatable seal element either being coupled to, or being a monolithic portion of the rotor. Such seals typically have the non-rotatable seal element movable axially and coupled to a portion of the stator. The rotatable and non-rotatable seal elements are generally annular, and perpendicular to the longitudinal axis of the rotor.

The variable gap between the rotor and the stator to be sealed is commonly accommodated by either providing a compliant seal that is held between the components, for example, using a leaf seal, or by creating a complex leakage path. However, such sealing systems are subject to wear and increased leakage over time. Thus, none of these seals meet all performance and durability requirements due to the initial gaps between components, and due to contact of the seals with adjacent surfaces.

There is a need for an improved sealing system.

### BRIEF DESCRIPTION

In accordance with one exemplary embodiment of the present invention, an aspirating face seal is disclosed. The aspirating face seal includes a primary seal, a secondary seal, and a biasing device. The primary seal includes a first seal component and a second seal component. The first seal component is configured to be coupled to a rotor and rotatable with the rotor. The secondary seal includes a plurality of flexible elements and configured to be disposed between the second seal component and a stator housing. A biasing device is coupled to the second seal component such that the second seal component is biased along an axial direction away from the first seal component during a non-operating condition.

In accordance with another exemplary embodiment of the present invention, a machine having an exemplary aspirating face seal is disclosed. The aspirating face seal is disposed between the stator housing and the rotor.

In accordance with another exemplary embodiment of the present invention, a method includes rotating a rotor disposed inside a stator housing, and operating an aspirating face seal disposed between the stator housing and the rotor. Operating the aspirating face seal includes biasing a second seal component along an axial direction against a first seal component of a primary seal, and providing a sealing between the second seal component and the stator housing via a secondary seal comprising a plurality of flexible elements.

In accordance with another exemplary embodiment of the present invention, a method includes removing an existing secondary seal from a second seal component configured to contact a first seal component of a primary seal, and replacing the existing secondary seal with a brush seal.

In accordance with another exemplary embodiment of the present invention, a method includes removing an existing secondary seal from a coupling device configured to couple a second seal component to a stator housing, and replacing the existing secondary seal with a brush seal.

### DRAWINGS

These and other features, aspects, and advantages of the present invention will become better understood when the following detailed description is read with reference to the accompanying drawings in which like characters represent like parts throughout the drawings, wherein:

FIG. 1 is a cross-sectional view of machine, for example a gas turbine engine, having an aspirating face seal in accordance with an exemplary embodiment of the present invention;

FIG. 2 is a diagrammatical view of a secondary seal of an aspirating face seal in accordance with the aspects of FIG. 1; and

FIG. 3 is a diagrammatical view of a secondary seal of an aspirating face seal in accordance with an exemplary embodiment of the present invention; and

FIG. 4 is a cross-sectional view of machine having an aspirating face seal with a conventional secondary seal.

### DETAILED DESCRIPTION

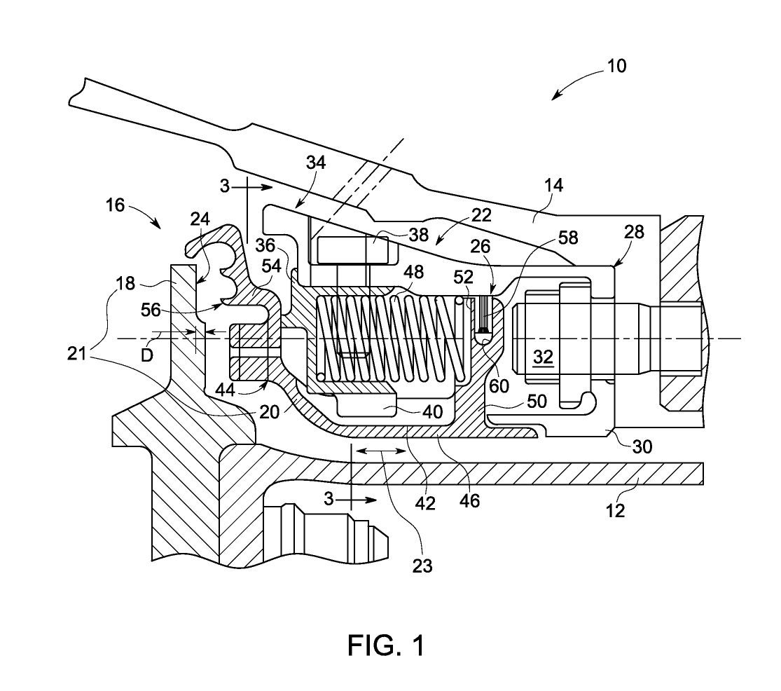

As discussed herein below with reference to embodiments of FIGS. 1-3, an aspirating face seal is disclosed. The exemplary aspirating face seal includes a primary seal having a first seal component and a second seal component. The first seal component is configured to be coupled to a rotor and rotatable with the rotor. A secondary seal having a plurality of flexible elements is disposed between the second seal component and a stator housing. A biasing device is coupled to the second seal component such that the second seal component is biased along an axial direction away from the first seal component during a non-operating condition. The second seal component is biased towards the first seal component during an operating condition. In a particular embodiment, a machine having the exemplary aspirating face seal is disclosed. In another embodiment, a method related to the aspirating face seal is disclosed. In some embodiments, the secondary seal is a brush seal. The usage of a brush seal as a secondary seal facilitates a reduction in the friction forces on the secondary seal, and thereby improves the dynamic behavior of the aspirating face seal.

Referring to FIG. 1, a machine 10 having a rotor 12, a stator housing 14, and an aspirating seal 16 is disclosed. The aspirating seal 16 is configured to control leakage of a pressurized fluid between a region of relatively high pressure and an area of relatively low pressure. In the illustrated embodiment, the machine 10 is a gas turbine engine, and the aspirating seal 16 is a compressor discharge pressure seal disposed between the rotor 12 and the stator housing 14. The rotor 12 is a core shaft and the stator housing 14 is a diffuser casing. Although a gas turbine engine is illustrated, the aspirating face seal 16 may be used in any application, where a self-adjusting seal is desirable or required. In some examples, without limitation, the machine 10 may be a centrifugal compressor, or a steam turbine, or a gas turbine, or a bearing, or a sump, or an electric generator, or the like. It may also be noted that the aspects of the present invention are not limited to an association with rotary machines and may be associated with other machines subjected to fluid pressure drop during machine operation.

The aspirating face seal 16 includes a first seal component 18, a second seal component 20, and a coupling device 22 disposed about a longitudinal axis of the machine 10. The first seal component 18 and the second seal component 20 together form a primary seal 21. The first seal component 18 is coupled to the rotor 12 and is rotatable with the rotor 12. The first seal component 18 is generally disk shaped and defines a first axially facing primary seal surface 24. The coupling device 22 is configured to couple the second seal component 20 to the stator housing 14. The coupling device 22 is a non-rotating, axially extending component and defines a radially facing secondary sealing surface 26. The coupling device 22 has an end 28 with a radially extending flange 30 secured to the stator housing 16 via one or more fasteners 32. Another end 34 of the coupling device 22 has one or more spring seats 36. The spring seat 36 is coupled to the coupling device 22 via one or more fasteners 38. The spring seat 36 includes a radially inward extending alignment rail 40 coupled to an alignment slot 42 of the second seal component 20. The second seal component 20 is coupled to the coupling device 22 such that the second seal component 20 is movable along an axial direction 23 and not laterally. The second seal component 20 has a generally L-shaped cross-section with a radially extending portion 44 and an axially extending portion 46.

In some embodiments, the coupling device 22 may be integrated with the stator housing 14. In certain other embodiments, the second seal component 20 may be directly coupled to the stator housing 14.

One or more biasing devices 48 such as springs are disposed between the spring seat 36 and a radially extending flange 50 of the second seal component 20. An end of the biasing device 48 is located in a spring pocket 52 of the flange 50. The biasing device 48 is configured to bias the second seal component 20 away from the first seal component 18.

The second seal component 20 has a radially extending portion 54 defining an axially facing second primary sealing surface 56. The second primary sealing surface 56 is disposed in close proximity to the first seal component 18 and faces the first primary sealing surface 24. The first and second primary sealing surfaces 24, 56 are configured in such a way so as to form a circuitous or tortuous path for flow of fluid. The radially extending portion 54 of the second seal component 20 has fluid passages (not shown) for hydrostatic balancing of the second seal component 20.

A secondary seal 58 is disposed in a groove 60 in the flange 50 of the second seal component 20. In the illustrated embodiment, the secondary seal 58 is a brush seal. The secondary seal 58 is configured to provide sealing against the radially facing secondary sealing surface 26 of the coupling device 22. The purpose of the secondary seal 58 is to prevent leakage of fluid through a path between the second seal component 20 and the coupling device 22. It should be noted herein that the secondary seal 58 is subjected to the same pressure differential as the primary seal 21, while allowing movement of the second seal component 20 along the axial direction 23. It should be reiterated herein that the specific configuration of the seal components and mounting structure described herein is not limiting and may be varied to suit a particular application without affecting the functional aspects of the aspirating face seal 16.

Referring to the operation of the aspirating face seal 16, the second seal component 20 forms a seal with the first seal component 18. The one or more biasing devices 48 bias the second seal component 20 away from the first seal component 18 to prevent contact between the first seal component 18 and the second seal component 20 when the machine 10 is stopped. As machine operating speed increases, the fluid pressure in fluid flow path areas increase. The aspirating face seal 16 is subjected to increasing pressures resulting in the second seal component 20 to move towards the first seal component 18. The second primary sealing surface 56 does not contact the first primary sealing surface 24. As discussed previously, the secondary seal 58 is configured to provide sealing against the radially facing secondary sealing surface 26 of the coupling device 22. The aspirating face seal 16 is hydrostatically pressure balanced at a selected operating condition.

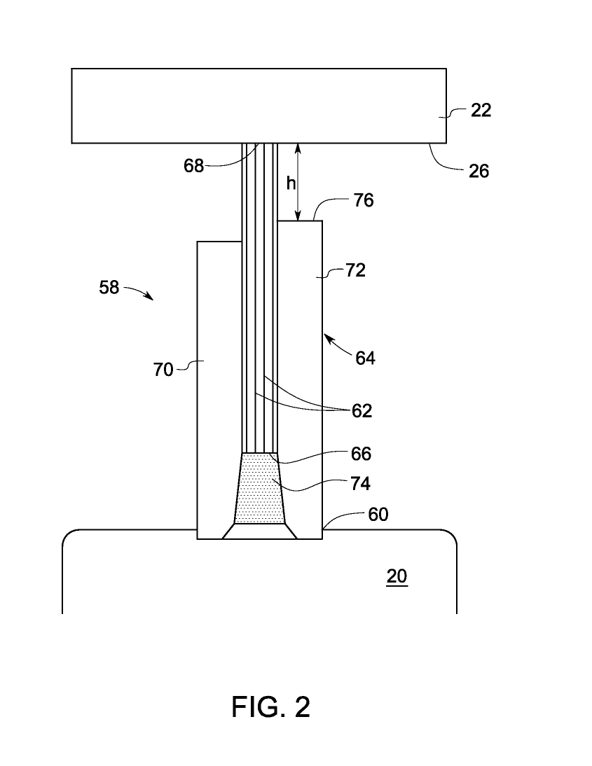

Referring to FIG. 2, the secondary seal 58 in accordance with the aspects of FIG. 1 is explained in greater detail herein. The secondary seal 58 includes a plurality of flexible elements 62, coupled to a holding device 64. It should be noted herein that the term “flexible element” may be referred to as an element that is capable of being bent without breaking the element. In some embodiments, the plurality of flexible elements 62 comprises bristles, which may include metallic, or non-metallic bristles or a combination of metallic and non-metallic bristles. In certain embodiments, the flexible elements 62 may include metal alloy, for example, a cobalt alloy, such as HAYNES25®. A flexible bristle is a cantilevered beam whose radial stiffness is defined by the length, cross-sectional moment of inertia, and material modulus of elasticity. In accordance with aspects of the present invention, each flexible element 62 has a diameter in the range of 2 to 8 mils. It should be noted herein that aspects of the present invention may also be applicable to other types of bristles. The flexible elements 62 are canted at a lay angle in the range of 75 to 15 degrees so as to control the pressure-blow down effect and friction. As discussed above, the secondary seal 58 is disposed in the groove 60 of the second seal component 20. The secondary seal 58 is configured to provide sealing against the radially facing secondary sealing surface 26 of the coupling device 22. The specific dimensions and canting of flexible elements 62 improves the compliance of the seal with the coupling device 22.

Each flexible element 62 includes a first end 66 coupled to the holding device 64 and a second end 68 disposed proximate to the coupling device 22. In certain exemplary embodiments, the second end 68 of the flexible element 62 contacts the coupling device 22. The flexible element 62 allows relatively large radial motion of the unrestrained end 68, which in turn allows sealing of a gap between the coupling device 22 and the second seal component 20. In the illustrated embodiment, the holding device 64 includes a front plate 70, a back plate 72, and a matrix 74 disposed between the front plate 70 and the back plate 72. In certain exemplary embodiments, the front and back plates 70, 72 include a metallic material, or a composite material, or a combination thereof. The flexible elements 62 are clamped between the front and back plates 70, 72. The first end 66 of each flexible element 62 is coupled to the matrix 74 and the second end 68 protrudes from the plates 70, 72 towards the coupling device 22. In certain embodiments, the matrix 74 may include a welded connection comprising a mixture of the flexible element and side plate materials. In some embodiments, the matrix 74 may include epoxy, polyimide, or the like. The matrix 74 is used to affix the flexible elements 62 to the front and back plates 70, 72.

The pressure drop capability of the secondary seal 58 is closely related to the fence height “h”. It should be noted herein that the fence height “h” is the distance between the radially facing secondary sealing surface 26 of the coupling device 22 and a bottom edge 76 of the back plate 72 supporting the flexible elements 62. In the illustrated embodiment, provision of the secondary seal 58 between the non-rotatable second seal component 20 and the coupling device 22 facilitates the fence height “h” to be reduced. In the illustrated embodiment, the fence height “h” of the secondary seal 58 has a fence height “h” in a range of 5 to 50 mils. In a specific embodiment, the fence height “h” may be in the range of 10 to 20 mils. In conventional systems, a brush seal is normally used to seal between a stator and a rotor, and therefore requires relatively large fence heights to avoid possible component damage due to rubs between the rotor and the stator. The pressure capability of the exemplary secondary seal 58 is increased commensurately compared to conventional systems because the risk of the back plate 72 rubbing against the surface 26 of the coupling device 22, so as to cause damage to the coupling device 22, is reduced.

It should be noted herein that the flexible elements 62 are packed close together so as to maintain a larger pressure differential between a low-pressure region and a high pressure region. In accordance with the exemplary embodiment discussed herein, the secondary seal 58 with a relatively lower fence height is used between the coupling device 22 and the axially movable second seal component 20 so as to reduce the friction forces acting on the secondary seal 58 compared to the conventional secondary seal of an aspirating face seal. It should be noted herein that although a brush seal is discussed herein with reference to the secondary seal 58, in some embodiments, the secondary seal 58 might also include a seal having a plurality of other flexible elements. It should be noted herein that the flexible element 62 is compliant to the thermal growth mismatch between the second seal component 20 and the coupling device 22. The flexible element 62 also has low hysteresis to minimize friction drag between the second seal component 20 and the coupling device 22. Other examples of “flexible elements” include but not limited to angled shims (such as in a leaf seal), finger seal, shingled foil seal, spring-backed “shoes” that are allowed to move radially by being supported on soft springs, or the like.

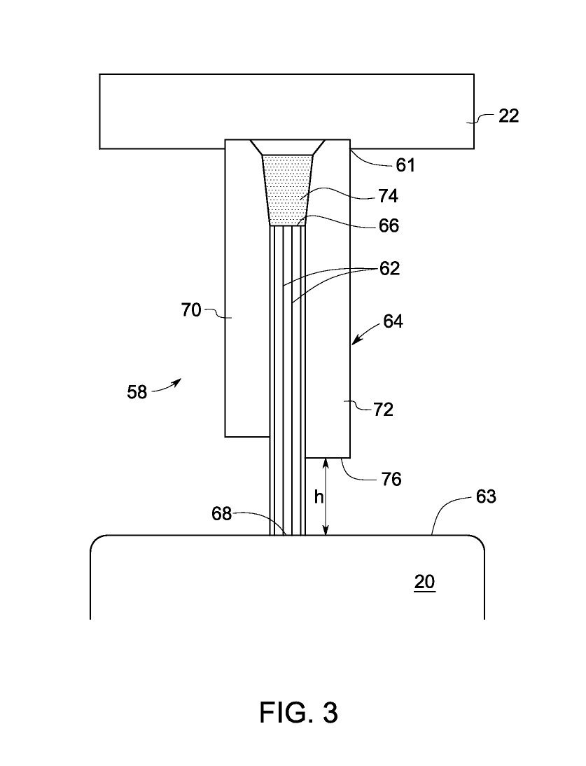

Referring to FIG. 3, the secondary seal 58 in accordance with an exemplary embodiment of the present invention is disclosed. The configuration of the secondary seal 58 is similar to the embodiment of FIG. 2, except that the secondary seal 58 is disposed in a groove 61 of the coupling device 22. In the illustrated embodiment, the secondary seal 58 is configured to provide sealing against a sealing surface 63 of the second seal component 20.

The first end 66 of each flexible element 62 is coupled to the holding device 64 and the second end 68 is disposed proximate to the second seal component 20. In certain exemplary embodiments, the second end 68 of the flexible element 62 contacts the second seal component 20. It should be noted herein that the fence height “h” is the distance between the sealing surface 63 of the second seal component 20 and the bottom edge 76 of the back plate 72 supporting the flexible elements 62. In accordance with the exemplary embodiment discussed herein, the secondary seal 58 with a relatively lower fence height is used between the coupling device 22 and the axially movable second seal component 20 so as to reduce the friction forces acting on the secondary seal 58 compared to the conventional secondary seal of an aspirating face seal. In some embodiments, the secondary seal 58 is disposed in a groove of the stator housing and configured to provide sealing against a sealing surface 63 of the second seal component 20.

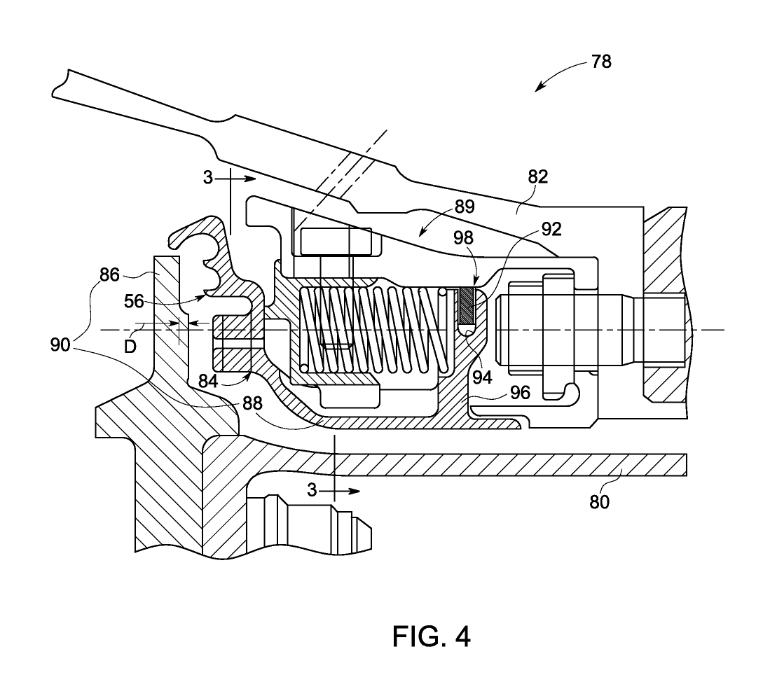

Referring to FIG. 4, a machine 78 having a rotor 80, a stator housing 82, and an aspirating seal 84 is disclosed. The aspirating face seal 84 includes a first seal component 86, a second seal component 88, and a coupling device 89 disposed about a longitudinal axis of the machine 78. The first seal component 86 and the second seal component 88 together form a primary seal 90. The first seal component 86 is coupled to the rotor 80 and rotatable with the rotor 80. The coupling device 89 is configured to couple to couple the second seal component 88 to the stator housing 82.

In the illustrated embodiment, a conventional secondary seal 92 is disposed in a groove 94 in a flange 96 of the second seal component 88. The conventional secondary seal 92 is configured to provide sealing against a radially facing secondary sealing surface 98 of the coupling device 89. The conventional secondary seal 92 may be any conventional seal such as a piston ring. In certain existing machines 78, the conventional secondary seal 92 may be coupled to the coupling device 89 or may be directly coupled to the stator housing 82 and configured to provide sealing against a sealing surface of the second seal component 88. In accordance with the aspects of the present invention, the machine 78 is modified by removing the existing conventional secondary seal 92 and replacing the existing conventional secondary seal 92 with an exemplary brush seal similar to the secondary seal 58 discussed with reference to FIGS. 1, 2, and 3. The grooves, for example the groove 94, may be sized to accommodate the secondary seal 58.

The usage of such an exemplary brush seal as a secondary seal facilitates a reduction in the friction forces acting on the secondary seal, compared to the existing secondary seal 92. As a result, the dynamic behavior and life of the secondary seal is substantially increased.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An aspirating face seal comprising:
a primary seal comprising a first seal component and a second seal component; wherein the first seal component is configured to be coupled to a rotor and rotatable with the rotor;
a secondary seal comprising a plurality of flexible elements and configured to be disposed between the second seal component and a stator housing; and
a biasing device coupled to the second seal component such that the second seal component is biased along an axial direction away from the first seal component during a non-operating condition.

2. The aspirating face seal of claim 1, wherein the secondary seal comprises a brush seal including a holding device and the plurality of flexible elements comprising a plurality of bristles, each bristle having a first end coupled to the holding device and a second end protruding from the holding device.

3. The aspirating face seal of claim 2, wherein each bristle has a diameter in the range of 2 to 8 mils.

4. The aspirating face seal of claim 2, wherein each bristle has a lay angle in the range of 75 to 15 degrees.

5. The aspirating face seal 1, wherein the secondary seal has a fence height in the range of 5 to 50 mils.

6. A machine, comprising:
a stator housing;
a rotor disposed in the stator housing; and
an aspirating face seal disposed between the stator housing and the rotor, the aspirating face seal comprising:
a primary seal comprising a first seal component and a second seal component; wherein the first seal component is coupled to the rotor and rotatable with the rotor;
a secondary seal comprising a plurality of flexible elements disposed between the second seal component and the stator housing; and
a biasing device coupled to the second seal component such that the second seal component is biased along an axial direction away from the first seal component during a non-operating condition of the machine.

7. The machine of claim 6, further comprising a coupling device for coupling the second seal component to the stator housing.

8. The machine of claim 7, wherein the secondary seal is coupled to the second seal component so as to contact the coupling device.

9. The machine of claim 8, wherein the secondary seal comprises a brush seal including a holding device coupled to the second seal component, and the plurality of flexible elements comprising a plurality of bristles, each bristle having a first end coupled to the holding device and a second end protruding from the holding device to contact the coupling device.

10. The machine of claim 9, wherein the second end of each bristle contacts the coupling device so as to control leakage of a pressurized fluid between the second seal component and the coupling device during the operating condition of the machine.

11. The machine of claim 9, wherein each bristle has a diameter in the range of 2 to 8 mils.

12. The machine of claim 9, wherein each bristle has a lay angle in the range of 75 to 15 degrees.

13. The machine of claim 7, wherein the secondary seal is coupled to the coupling device so as to contact the second seal component.

14. The machine of claim 13, wherein the secondary seal comprises a brush seal including a holding device coupled to the coupling device, and the plurality of flexible elements comprising a plurality of bristles, each bristle having a first end coupled to the holding device and a second end protruding from the holding device to contact the second seal component.

15. The machine of claim 6, wherein the secondary seal has a fence height in the range of 5 to 50 mils.

16. A method comprising:
rotating a rotor disposed inside a stator housing; and
operating an aspirating face seal disposed between the stator housing and the rotor, comprising:
biasing a second seal component along an axial direction against a first seal component of a primary seal, wherein the first seal component is coupled to the rotor and the second seal component is coupled to the stator housing; and
providing a sealing between the second seal component and the stator housing via a secondary seal comprising a plurality of flexible elements.

17. The method of claim 16, comprising contacting an end of the plurality of flexible elements comprising a plurality of bristles of the secondary seal against a coupling device configured to couple the second seal component to the stator housing, so as to control leakage of a pressurized fluid between the second seal component and the coupling device.

18. The method of claim 17, wherein each bristle has a diameter in the range of 2 to 8 mils.

19. The method of claim 17, wherein each bristle has a lay angle in the range of 75 to 15 degrees.

20. The method of claim 16, comprising contacting an end of the plurality of flexible elements comprising a plurality of bristles of the secondary seal against the second seal component, so as to control leakage of a pressurized fluid between the second seal component and a coupling device configured to couple the second seal component to the stator housing, wherein the secondary seal is coupled to the coupling device.

21. The method of claim 16, wherein the secondary seal has a fence height in the range of 5 to 50 mils.

22. A method comprising:
removing an existing secondary seal from a second seal component configured to contact a first seal component of a primary seal; wherein the first seal component is coupled to a rotor and the second seal component is coupled to a stator housing via a coupling device; and
replacing the existing secondary seal with a brush seal, wherein an end of a plurality of bristles of the brush seal contact the coupling device to control leakage of a pressurized fluid between the second seal component and the coupling device.

23. The method of claim 22, wherein the brush seal has a fence height in the range of 5 to 50 mils.

24. A method comprising:
removing an existing secondary seal from a coupling device configured to couple a second seal component to a stator housing, wherein the existing secondary seal contacts a second seal component configured to contact a first seal component of a primary seal; wherein the first seal component is coupled to a rotor; and
replacing the existing secondary seal with a brush seal, wherein an end of a plurality of bristles of the brush seal contacts the second seal component so as to control leakage of a pressurized fluid between the second seal component and the coupling device.
